(19) United States
(12) Patent Application Publication
(10) Pub. No.: US 2012/0250216 A1
(43) Pub. Date: Oct. 4, 2012

(54) SEMICONDUCTOR CERAMIC AND A MULTILAYER SEMICONDUCTOR CERAMIC CAPACITOR

(75) Inventors: Tatsuya ISHII, Tokyo (JP); Kenichiro MASUDA, Tokyo (JP); Shigekazu HIDAKA, Tokyo (JP); Hidesada NATSUI, Tokyo (JP); Takeo TSUKADA, Tokyo (JP)

(73) Assignee: TDK CORPORATION, TOKYO (JP)

(21) Appl. No.: 13/431,486

(22) Filed: Mar. 27, 2012

(30) Foreign Application Priority Data
Mar. 29, 2011 (JP) 2011-073337

(51) Int. Cl. H01B 1/08; H01G 4/30

(52) U.S. Cl. 361/301.4; 252/519.12

(57) ABSTRACT

A purpose of the present invention is to provide a multilayer semiconductor ceramic capacitor, which makes coexistence of a high dielectric property and a high insulating resistance of a semiconductor ceramic possible by improving insulating property of the semiconductor ceramic component. In order to achieve such object, BaTiO₃ based semiconductor ceramic of the invention is expressed by Ba_{A}(Ti_{1-α-β}Ga_{α}Nb_{β})_{B}O₃, wherein A/B mole ratio is within a range of 0.900 or more to 1.060 or less and α/β mole ratio is within a range of 0.92 or more to 100 or less.

### BACKGROUND OF THE INVENTION

1. Field of the Invention

The present invention relates to a semiconductor ceramic and to a multilayer semiconductor ceramic capacitor. More precisely, the present invention relates to a BaTiO₃ based grain boundary insulating type semiconductor ceramic and to a multilayer semiconductor ceramic capacitor using thereof.

2. Description of the Related Art

In recent years, with the development of electronic technology, downsizing for electronic components is rapidly proceeding. There is also a high requirement for downsizing and larger capacitance in the area of multilayer ceramic capacitor, thus, development of a ceramic material having a high specific permittivity and also thinning and multi-layering of dielectric ceramic layers are proceeding.

For instance, Japanese unexamined patent publication No. H11-302072 discloses a dielectric ceramic expressed by a general formula: {Ba_{1-x-y}CaₓRe_{y}O}ₘTiO₂+αMgO+βMnO wherein “Re” is a rare earth element selected from a group Y, Gd, Tb, Dy, Ho, Er and Yb and “α”, “β”, “m”, “x” and “y” are respectively 0.001≦α≦0.05, 0.001≦β≦0.025, 1.000<m≦1.035, 0.02≦x≦0.15 and 0.001≦y≦0.06.

Japanese unexamined patent publication No. H11-302072 discloses a multilayer ceramic capacitor using said dielectric ceramic by which a multilayer ceramic capacitor wherein specific permittivity “∈r” of 1200 to 3000 and dielectric loss of 2.5% or less can be obtained, when a thickness of one ceramic layer is 2 μm and a total number of valid dielectric ceramic layers is 5.

Further, SrTiO₃ based grain boundary insulating type semiconductor ceramic, in which crystal grain boundary is made to a dielectric material by firing (a primary firing) a ceramic compact under a strongly reductive atmosphere and then by re-firing (a secondary firing) under a oxidized atmosphere, shows approximately 200 specific permittivity “∈r” of SrTiO₃ itself, which is small, however, apparent specific permittivity “∈r_{APP}” can be increased by lengthening a crystal particle diameter and reducing a number of crystal grain boundary since capacitance is obtained in crystal grain boundary.

For instance, Japanese patent No. 2689439 discloses SrTiO₃ based grain boundary insulating type semiconductor ceramic body, wherein an average particle diameter of crystal particles is 10 μm or less and a maximum particle diameter is 20 μm or less. Although the semiconductor ceramic capacitor has a single layer structure, a semiconductor ceramic body in which apparent specific permittivity “∈r_{APP}” of 9000 when an average particle diameter of crystal particles is 8 μm can be obtained.

Further, Japanese unexamined patent publication No. 2007-180297 discloses SrTiO₃ based grain boundary insulating type semiconductor ceramic having large apparent specific permittivity of 5000 or more, even when an average particle diameter of crystal particles is atomized to 1 μm or less, and that materials correspond to thinning and multi-layering can be obtained.

However, when thinning and multi-layering of ceramic layer using dielectric ceramic of Japanese unexamined patent publication No. H11-302072 are proceeded, there were problems such as decrease in specific permittivity, temperature characteristic deterioration of capacitance, short circuit deficiency, and etc.

Thus, when a multilayer ceramic capacitor wherein thinned layer has a large-capacity, for instance 100 pF or more, is required, thickness of one dielectric ceramic layer must be around 1 μm and a number of multi-layering must be 700 to 1000 layers, and that it is a difficult situation to put into a practical use.

Further, an average particle diameter of semiconductor ceramic according to specification of Japanese Patent No. 2689439 is 8 μm in order to obtain a large apparent specific permittivity, and not designed for thinning and multi-layering.

Semiconductor ceramic of Japanese unexamined patent publication No. 2007-180297 is SrTiO₃ based semiconductor ceramic, and although its average particle diameter is suppressed to 1 μm or less in order to correspond to thinning and multi-layering, 5000 or more of large apparent specific permittivity can be obtained. Further, in order to form grain boundary insulating layer, a secondary firing (reoxidation treatment) is required and desired characteristic can be obtained even under an air atmosphere or an atmosphere where oxygen concentration is slightly lowered. This shows that resistance of semiconductor ceramic itself is low and that such treatment is required.

On the other hand, apparent specific permittivity of BaTiO₃ based grain boundary insulating type semiconductor ceramic is high and that application to the filed of capacitor is expected. However, there was a problem that although it is necessary to thicken the insulating coating layer in order to maintain insulating resistance when conductivity of semiconductor ceramic is too high, apparent specific permittivity decreases when said insulating coating layer is thickened.

### BRIEF SUMMARY OF THE INVENTION

The present invention has been made by considering the above circumstances, and a purpose of the present invention is to provide a multilayer semiconductor ceramic capacitor, which makes coexistence of a high dielectric property and a high insulating resistance of a semiconductor ceramic possible and which can correspond to thinning and multi-layering, by improving insulating property of the semiconductor ceramic component.

In order to achieve such object, as a result of intentional study by the present inventors, semiconductor ceramic fine particles, in which BaTiO₃ wherein a part of Ti site is substituted by specific amount of Ga and Nb, compounding mole ratio A/B of Ba site and Ti site is 0.900≦A/B≦1.060 and Ga/Nb mole ratio is 0.92≦α/β≦100, are heat treated and then, a sintered body showing apparent specific permittivity of 5000 or more and resistivity of 10⁷ Ω·μm or more was obtained, which lead to achieve the completion of the present invention.

Namely, scope of the present invention solving the above object is as follows;

(1) A BaTiO₃ based semiconductor ceramic in which Ti site of BaTiO₃ is simultaneously substituted by Ga and Nb.

(2) A BaTiO₃ based semiconductor ceramic which is expressed by Ba_{A}(Ti_{1-α-β}Ga_{α}Nb_{β})_{B}O₃, wherein α/β mole ratio is within a range of 0.92≦α/β≦100.

(3) The BaTiO₃ based semiconductor ceramic of the above (2), wherein A/B mole ratio is within a range of 0.900 to 1.060.

(4) A BaTiO₃ based semiconductor ceramic powder in which Ti site of BaTiO₃ is simultaneously substituted by Ga and Nb, wherein a maximum particle diameter of the BaTiO₃ based semiconductor ceramic powder is 1 μm or less.

(5) A BaTiO₃ based semiconductor ceramic powder which is expressed by Ba_{A}(Ti_{1-α-β}Ga_{α}Nb_{β})_{B}O₃, wherein α/β mole ratio is within a range of 0.92 or more to 100 or less and a maximum particle diameter is 1 μm or less.

(6) The BaTiO₃ based semiconductor ceramic powder of the above (5), wherein A/B mole ratio is within a range of 0.900 or more to 1.060 or less.

(7) A multilayer semiconductor ceramic capacitor having a component body in which a semiconductor ceramic layer and an internal electrode are alternately stacked, wherein said semiconductor ceramic layer is constituted from BaTiO₃ based semiconductor ceramic of either above (1) or (2).

By using BaTiO₃ based semiconductor ceramic of the present invention which is expressed by Ba_{A}(Ti_{1-α-β}Ga_{α}Nb_{β})_{B}O₃, wherein A/B mole ratio is within a range of 0.900 to 1.060, α/β mole ratio is within a range of 0.92≦α/β≦100, apparent specific permittivity of 5000 or more and resistivity of 10⁷ Ω·μm or more can be obtained. And even with a thin layer, a semiconductor ceramic having a large capacitance when compared to the conventional dielectric ceramic can be obtained.

Further, according to the multilayer semiconductor ceramic capacitor of the present invention, a component body is formed by the above-mentioned semiconductor ceramic, an internal electrode is set to the component body, and an external electrode electrically connectable with the internal electrode is set on a surface of the component body. Therefore, even a semiconductor ceramic layer constituting the component body is thinned to approximately 1 μm, multilayer semiconductor ceramic capacitor having large apparent specific permittivity can be obtained. Thus, in comparison with the conventional multilayer ceramic capacitor, a multilayer semiconductor ceramic capacitor having a thinned layer and a large capacity is possible to be realized.

### BRIEF DESCRIPTION OF THE DRAWINGS

FIG. 1 is a cross-sectional view of a multilayer ceramic capacitor according to an embodiment of the present invention.

FIG. 2 is a graph showing XRD results according to examples of the present invention.

### DETAILED DESCRIPTION OF THE INVENTION

Hereinafter, the present invention will be described based on embodiments shown in drawings.

A semiconductor ceramic according to an embodiment of the present embodiment is a BaTiO₃ based grain boundary insulating type semiconductor ceramic, which is expressed by Ba_{A}(Ti_{1-α-β}Ga_{α}Nb_{β})_{B}O₃ wherein A/B mole ratio is within a range of 0.900 to 1.060 and α/β mole ratio is within a range of 0.92≦α/β≦100, and is fine particles of 1 μm or less.

A sintered body, obtained by heat treating the above fine particles, provides apparent specific permittivity of 5000 or more and resistivity of 10⁷ Ω·μm or more, and is preferable for thinning and multi-layering; and that a size-reduced large capacity multilayer semiconductor ceramic can be obtained.

Below is a reason to limit A/B mole ratio and α/β mole ratio within the above range.

A/B mole ratio affects a particle diameter of semiconductor ceramic. When A/B mole ratio is less than 0.900, reactivity increases in producing BaTiO₃ and makes it ease for a particle growth. Therefore, it is difficult to obtain fine particles, and that a desired particle diameter cannot be obtained. While when A/B mole ratio is over 1.060, Ba ratio increases and that Ba-rich ortho barium titanate (Ba₂TiO₄) generates as a different phase, which is not preferable.

Nb takes a role in becoming a semiconductor, and generates Ti³⁺ when doped to Ti site. Transfer of electron is likely to occur when this Ti³⁺ exists, and that resistivity is thought to decrease. Ga takes a role in becoming an insulator, and that transfer of electron cannot be realized where Ga is doped. As a result, transfer of electron is difficult to realize and resistivity is thought to increase. Therefore, insulating property increases when Ga/Nb ratio is large while conductivity increases when Ga/Nb ratio is small. When Ga/Nb ratio is less than 0.92, conductivity increases and resistivity becomes less than 10⁷ Ω·μm, and that it becomes difficult to secure an insulating resistance. Further, insulating property increases when Ga/Nb ratio is over 100, apparent specific permittivity becomes less than 5000 and that desired property cannot be obtained.

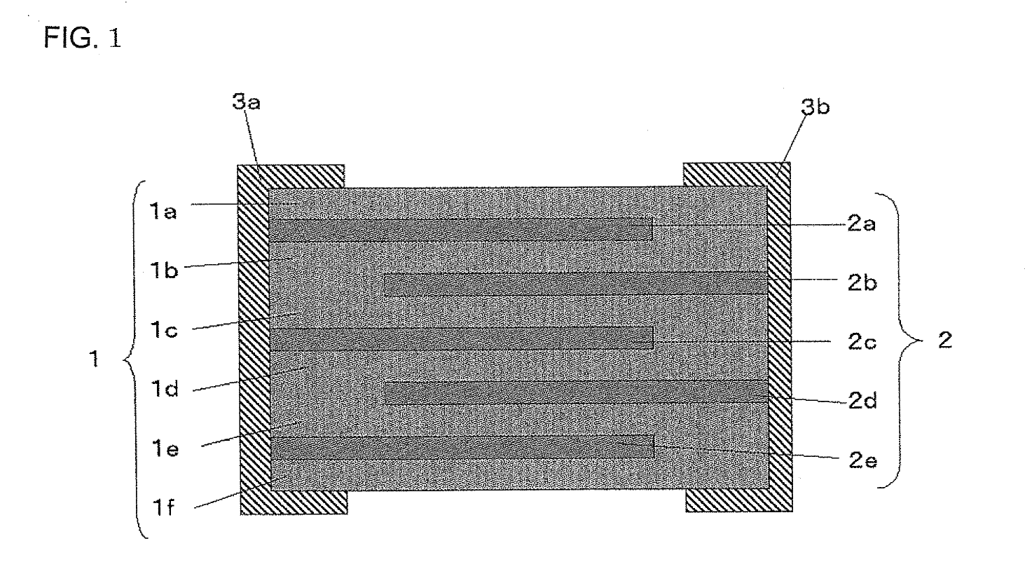

FIG. 1 is a schematic cross-sectional view of an embodiment of a multilayer semiconductor ceramic capacitor manufactured by using a semiconductor ceramic according to the present invention.

The multilayer semiconductor ceramic capacitor is a component body 1 comprising semiconductor ceramic of the present invention, wherein internal electrodes 2 (2a˜2e) are varied and external electrodes 3a, 3b are formed on both sides of said component body 1.

Namely, component body 1 comprises a multilayer sintered body of a plural number of semiconductor ceramic layers 1a to 1f, in which semiconductor ceramic layers 1a to if and internal electrodes 2a to 2e are alternately stacked, wherein internal electrodes 2a, 2c, 2e and external electrode 3a are electrically connected and internal electrodes 2b, 2d and external electrode 3b are electrically connected. Further, capacitance is formed between opposing faces of internal electrodes 2a, 2c, 2e and internal electrodes 2b, 2d.

The above multilayer semiconductor ceramic capacitor is manufactured as below.

When manufacturing BaTiO₃ based semiconductor fine particles according to the present embodiment, BaTiO₃ raw materials having a predetermined particle property, gallium included powder and niobium included powder are prepared at first.

As for raw materials of barium titanate, barium carbonate powders (BaCO₃) and titanium dioxide powders (TiO₂) are preferably used in the present embodiment.

Specific surface area of barium carbonate powders is preferably 20 m²/g or more, more preferably within a range of 30 to 100 m²/g. Specific surface area of titanium dioxide powders is preferably 30 m²/g or more, more preferably within a range of 40 to 100 m²/g.

Gallium included powders and Niobium included powders can be oxides or may be carbonate, oxalate, nitrate, hydroxide, organic metallic compound, etc. For reasons of particle property regulation, availability, etc., oxides are preferably used.

Specific surface area of gallium included powder and niobium included powder is preferably 5.0 m²/g or more, more preferably within a range of 10 to 100 m²/g.

When specific surface area of barium carbonate powders, titanium dioxide powders, gallium included powders and niobium included powders as raw materials are within the above range, barium titanate powders of fine and uniform particle size can be obtained. When raw material powders of coarse particles having relatively small specific surface area is used, barium titanate can be obtained while fine particles is difficult to be obtained.

Next, the prepared raw materials were weighed and mixed to become a predetermined compositional ratio, pulverized when necessary, and then a raw material mixture was obtained. As for a method to mix and pulverize, a wet method, wherein raw materials together with solvent such as water are put in a well-known pulverizing container such as ball mill, mixed and pulverized, can be exemplified. Further, mixture and pulverization can also be performed by a dry method using a dry mixer. Note that specific surface area of raw material powders can be adjusted within the above identified range by pulverization when preparing the mixed powders. Further, when mixing and pulverizing, in order to improve dispersibility of the put raw materials, dispersants are preferably added. A Well-known dispersant can be used for the dispersants.

Next, the obtained raw material mixtures were dried when necessary, and then heat treated. Temperature rising rate of the heat treatment is preferably 50 to 900° C./hour. Further, in order to obtain barium titanate powders having small particle diameter and uniform particle size, the heat treatment temperature is preferably 900° C. or more to lower than 1200° C., more preferably, 950 to 1150° C. Holding time is preferably 0.5 to 5 hours, more preferably 2 to 4 hours.

Further, although heat treatment atmosphere may be either a reduced atmosphere or an air atmosphere, an air atmosphere is preferable.

By performing such heat treatment, gallium and niobium are substituted to Ti site of BaTiO₃ and solid soluted so that production of barium titanate is accelerated.

Note that when temperature holding time is too low, raw materials beyond reacting, e.g. BaCO₃, tends to remain.

And then, when holding time of heat treatment has passed, holding temperature at heat treatment is cooled to a room temperature.

This will allow obtaining fine particles of barium titanate. Composition of barium titanate powders, A/B ratio, etc. are controlled within the range mentioned above, fine particles having uniform particle diameter can be obtained.

Next, a low-melting-point oxide is added to make contained molar amount of the low-melting-point oxide, such as SiO₂, to be 0.5 mole with respect to 100 moles of Ti element. And then the abovementioned preliminarily calcined powders, water and together with dispersants when necessary are put in a ball mill. In said ball mill, evaporative drying after a sufficient wet-mixing is performed, and then, heat treatment is performed under air atmosphere at predetermined temperature, e.g. 500° C., for approximately 3 hours to manufacture heat treated powders.

Next, transition metal compound is added in order to make contained molar amount of transition metal element, such as Mn, is 0.3 mole with respect to 100 moles of Ti element, and a suitable amount of organic solvent such as alcohol fuel and dispersants are further added. The obtained substance is subsequently put into a ball mill together with the above pulverized medium and water, sufficiently wet-mixed in the ball-mill, and then a suitable amount of organic binder and plasticizer are added and sufficiently wet-mixed for a long time to obtain ceramic slurry.

Next, a forming process is applied to the ceramic slurry by using a forming process method such as doctor blade method and manufacture ceramic green sheet so that a thickness after firing to become a predetermined thickness, e.g. approximately 1 to 2 μm.

Next, a screen printing was performed on a ceramic green sheet by using conductivity paste for internal electrode, conducting film of a predetermined pattern is formed on a surface of the ceramic green sheet.

Note that, although a conductivity material included in conductivity paste for internal electrode is not particularly limited, when certainty of Ohmic contact with the semiconductor ceramic layer and a lower-cost is considered, base metal materials such as Ni and Cu may be preferably used.

Next, a plural number of ceramic green sheets wherein conducting film is formed are stacked in a predetermined direction, the stacked sheets are sandwiched by ceramic green sheets wherein conducting film is not formed, pressure bonded and cut into a predetermined size to manufacture a ceramic stacked body.

And then, a removal binder treatment is performed under an air atmosphere at 300 to 500° C., and then, a primary firing is performed under a strongly reducing atmosphere, wherein a predetermined flow ratio of H₂ gas and N₂ gas (e.g. H₂:N₂=1:100) is prepared, at 1150 to 1300° C. for 2 hours to sinter a ceramic stacked body.

And then, a secondary firing is performed under a nitrogen-water vapor atmosphere at a low temperature of 600 to 1100° C. for 2 hours, in order not to oxidize internal electrode material such as Ni or Cu, a grain boundary insulating layer is formed by reoxidation of a semiconductor ceramic, and then component body 1 in which internal electrodes 2 are buried is manufactured.

Next, a conductivity paste for an external electrode is coated on both sides of component body 1, baking treatment is performed, external electrodes 3a, 3b are formed, and then a multilayer semiconductor ceramic capacitor is manufactured.

Note that, although conductivity material included in conductivity paste for external electrode is not particularly limited, materials suitable for Ohmic contact such as Ga, In, Ni, Cu may be preferably used. Further, Ag electrode can be formed on these electrodes suitable for Ohmic contact.

Further, as for a forming method of external electrodes 3a, 3b, a conductivity paste for the external electrodes can be coated on both sides of ceramic stacked body, and then firing treatment can be performed simultaneously with the ceramic stacked body.

Accordingly, since the present embodiment manufacture a multilayer semiconductor ceramic capacitor using the above-mentioned semiconductor ceramic, thickness of each semiconductor ceramic layer 1a to 1f can be 1 μm or less, in addition, apparent specific permittivity per a layer can be as large as 5000 or more even when the layer is thin, and that downsized multilayer semiconductor ceramic capacitor having large capacitance can be obtained.

Further, although FIG. 1 shows a multilayer semiconductor ceramic capacitor wherein a number of semiconductor ceramic layers 1a to 1f and internal electrodes 2a to 2e are alternately stacked, a multilayer semiconductor ceramic capacitor having a structure, wherein internal electrode is formed on a single sheet (e.g. thickness of approximately 200 μm) of semiconductor ceramic by such as vapor deposition, and then few layers (e.g. 2 or 3 layers) of such single sheet are bonded by such as adhesive agent, is also possible. Such structure is useful for such as a multilayer semiconductor ceramic capacitor used for a small capacitance.

Note that, the present invention is not limited to the above mentioned embodiment. Although solid solution is manufactured by a solid-phase method in the above embodiment, manufacturing method of the solid solution is not particularly limited and arbitrary method such as hydrothermal synthesis method, sol-gel method, hydrolysis method, coprecipitation method, etc., may be used.

### EXAMPLES

Below, although the present invention will be specified based on precise examples, the present invention is not limited to such examples.

### Examples 1 to 14

### Comparative Examples 1 to 4

As for a raw material powder, BaCO₃ (specific surface area 25 m²/g), TiO₂ (specific surface area: 50 m²/g), Ga₂O₃ (specific surface area: 10 m²/g) and Nb₂O₅ (specific surface area: 10 m²/g) were prepared and weighed so as to be the composition shown in Table 1.

TABLE 1

| | | | | | Properties of Synthesized Powders | | | | |
|---|---|---|---|---|---|---|---|---|---|
| | | | | | | An average | A maximum | Electric Properties | |
| | | Synthesis | | Ga/Nb | | particle | particle | of a Sintered body | |
| | | temperature | | ratio | Identification | diameter | diameter | | Resistivity |
| Samples | Compositions | (° C.) | A/B | (α/β) | Phase | (μm) | (μm) | Specific permittivity | (Ω · μm) |
| Comp. | BaTi_{0.895}Ga_{0.05}Nb_{0.055}O₃ | 1100 | 1.000 | 0.91 | BaTiO₃ | 0.18 | 0.34 | unmeasurable | 1 × 10³ |
| Ex. 1 | | | | | | | | | |
| Ex. 1 | BaTi_{0.896}Ga_{0.05}Nb_{0.545}O₃ | 1100 | 1.000 | 0.92 | BaTiO₃ | 0.15 | 0.35 | 105000 | 2 × 10⁷ |
| Ex. 2 | BaTi_{0.595}Ga_{0.2}Nb_{0.205}O₃ | 1100 | 1.000 | 0.98 | BaTiO₃ | 0.13 | 0.35 | 35000 | 4 × 10⁸ |
| Ex. 3 | BaTi_{0.5}Ga_{0.25}Nb_{0.25}O₃ | 1100 | 1.000 | 1.00 | BaTiO₃ | 0.13 | 0.38 | 28000 | 8 × 10⁸ |
| Ex. 4 | BaTi_{0.795}Ga_{0.105}Nb_{0.1}O₃ | 1000 | 1.000 | 1.05 | BaTiO₃ | 0.14 | 0.34 | 26000 | 5 × 10⁸ |
| Ex. 5 | BaTi_{0.845}Ga_{0.1}Nb_{0.055}O₃ | 1000 | 1.000 | 1.82 | BaTiO₃ | 0.14 | 0.33 | 21000 | 8 × 10⁹ |
| Ex. 6 | BaTi_{0.88}Ga_{0.1}Nb_{0.02}O₃ | 1000 | 1.000 | 5.00 | BaTiO₃ | 0.16 | 0.35 | 11000 | 2 × 10¹⁰ |
| Ex. 7 | BaTi_{0.899}Ga_{0.1}Nb_{0.001}O₃ | 1000 | 1.000 | 100 | BaTiO₃ | 0.18 | 0.45 | 5200 | 9 × 10¹⁰ |
| Comp. | BaTi_{0.89905}Ga_{0.1}Nb_{0.00095}O₃ | 1000 | 1.000 | 105 | BaTiO₃ | 0.19 | 0.45 | 4800 | 1 × 10¹¹ |
| Ex. 2 | | | | | | | | | |
| Comp. | Ba_{0.88}Ti_{0.795}Ga_{0.1}Nb_{0.105}O₃ | 900 | 0.880 | 0.95 | BaTiO₃ | 0.32 | 1.51 | 80000 | 3 × 10⁷ |
| Ex. 3 | | | | | | | | | |
| Ex. 8 | Ba_{0.9}Ti_{0.795}Ga_{0.1}Nb_{0.105}O₃ | 1000 | 0.900 | 0.95 | BaTiO₃ | 0.21 | 0.84 | 69000 | 7 × 10⁷ |
| Ex. 9 | Ba_{0.95}Ti_{0.795}Ga_{0.1}Nb_{0.105}O₃ | 1000 | 0.950 | 0.95 | BaTiO₃ | 0.18 | 0.48 | 61000 | 8 × 10⁷ |
| Ex. 10 | BaTi_{0.795}Ga_{0.1}Nb_{0.105}O₃ | 1100 | 1.000 | 0.95 | BaTiO₃ | 0.18 | 0.32 | 50000 | 6 × 10⁸ |
| Ex. 11 | Ba_{1.02}Ti_{0.795}Ga_{0.1}Nb_{0.105}O₃ | 1100 | 1.020 | 0.95 | BaTiO₃ | 0.12 | 0.32 | 44000 | 8 × 10⁸ |
| Ex. 12 | Ba_{1.04}Ti_{0.795}Ga_{0.1}Nb_{0.105}O₃ | 1200 | 1.040 | 0.95 | BaTiO₃ | 0.12 | 0.30 | 40000 | 9 × 10⁸ |
| Ex. 13 | Ba_{1.05}Ti_{0.795}Ga_{0.1}Nb_{0.105}O₃ | 1200 | 1.050 | 0.95 | BaTiO₃ | 0.11 | 0.29 | 28000 | 2 × 10⁹ |
| Ex. 14 | Ba_{1.05}Ti_{0.795}Ga_{0.1}Nb_{0.105}O₃ | 1200 | 1.060 | 0.95 | BaTiO₃ | 0.10 | 0.27 | 27000 | 3 × 10⁹ |
| Comp. | Ba_{1.05}Ti_{0.795}Ga_{0.1}Nb_{0.105}O₃ | 1200 | 1.065 | 0.95 | Ba₂TiO₄, | 0.09 | 0.26 | 27000 | 5 × 10⁹ |
| Ex. 4 | | | | | BaTiO₃ | | | | |

Next, the weighed raw material powders were mixed by a ball mill together with water and dispersants, and then raw material mixtures were prepared. The prepared mixed powder was treated under the below mentioned heat treatment condition, and then barium titanate based semiconductor fine particles were manufactured.

Heat treatment conditions were a temperature rising rate: 200° C./hour, a holding temperature: temperatures shown in Table 1, temperature holding time: 2 hours, cooling rate: 200° C./hour and in an air atmosphere.

As defined above, barium titanate based semiconductor fine particles which contribute to thinning of dielectric layer were obtained.

Note that the obtained barium titanate based semiconductor fine particles were confirmed to be in consistency with the composition shown in Table 1 by a glass beads method using X-ray fluorescence instrument (Simultix 3530 by Rigaku Co., Ltd.).

(Evaluation)

An Identification Phase of Barium Titanate Based Semiconductor Fine Particles

Crystal structure of the obtained barium titanate based semiconductor fine particles was considered from diffraction pattern obtained from a powder X-ray diffraction measurement. X-ray diffraction used Cu-Kα-ray as X-ray source and its measurement conditions were; electric voltage of 45 kV, electric current of 40 mA, within a range of 2θ=20° to 90°, scan rate of 4.0 deg/min, and integrated time of 30 sec. In the present examples, an example without deposition of different phase (Ba₂TiO₄ phase) was determined to be good. Results are shown in Table 1.

Particle Properties of Barium Titanate Based Semiconductor Fine Particles

Particle properties of the obtained barium titanate based semiconductor fine particles were observed and measured by SEM observing 1000 particles, and then an average particle diameter and a maximum particle diameter were calculated from a circle equivalent converted diameter of each particle. In the present examples, the maximum particle diameter of preferably 1 μm or less were determined good, and 0.8 μm or less were more preferable. Results are shown in Table 1.

### Specific Permittivity of Sintered Body

1 wt % of polyvinyl alcohol solution as granulating agent was added to the obtained barium titanate based semiconductor fine particle powders, and after the granulation, pressure shaped to a disc shape of 12 mm diameter. After removing binder in air at 400° C. for 1 hour, the manufactured disc was sintered at 1350° C. in a mixed atmosphere of humidified nitrogen and hydrogen, and then annealed at 1000° C. in a humidified nitrogen atmosphere. In—Ga alloy was coated on the obtained sintered disc, and then its specific permittivity was measured by LCR meter (HP4284A by Hewlett Packard). The values in Table 1 were measured at 20° C., frequency of 1 kHz and electric voltage of 1 Vrms. In the present examples, specific permittivity of preferably 5000 or more were determined good and 10000 or more were more preferable. Results are shown in Table 1.

Resistivity of Sintered Body

Insulating resistance are the values after direct current of 1V was impressed for 30 seconds at a temperature of 20° C. and are mentioned in a form of resistivity (unit: Ω·μm). In the present examples, resistivity of preferably 10⁷ Ω·μm or more were determined good and 10⁸ Ω·μm or more were more preferable. Results are shown in Table 1.

As is shown in Table 1, when A/B mole ratio and α/β mole ratio of composition in barium titanate based semiconductor expressed by Ba_{A}(Ti_{1-α-β}Ga_{α}Nb_{β})_{B}O₃ are within a range of the present invention (examples 1 to 14), a different phase did not deposit, maximum particle diameter, specific permittivity and resistivity all showed good property and was confirmed that semiconductor fine particles which can correspond to thinning can be obtained.

On the other hand, as is shown in Table 1, when Ga/Nb ratio is less than 0.92 (Comp. Ex. 1) in composition of barium titanate based semiconductor expressed by Ba_{A}(Ti_{1-α-β}Ga_{α}Nb_{β})_{B}O₃, it was confirmed that resistivity of sintered body tends to become less than 10⁷ Ω·μm. Nb takes a role in becoming a semiconductor, and generates Ti³⁺ when doped to Ti site. Transfer of electron is likely to occur when this Ti³⁺ exists, and that resistivity is thought to decrease. Ga takes a role in becoming an insulator, and that transfer of electron cannot be realized where Ga is doped. As a result, transfer of electron is difficult to realize and resistivity is thought to increase.

Further, as is shown in Table 1, when Ga/Nb ratio is more than 100 (Comp. Ex. 2) in composition of barium titanate based semiconductor expressed by Ba_{A}(Ti_{1-α-β}Ga_{α}Nb_{β})_{B}O₃, it was confirmed that apparent specific permittivity tends to become less than 5000. Thus, when Nb ratio is small, conductivity decreases and that apparent specific permittivity is possible to decrease.

Further, as is shown in Table 1, when A/B ratio is less than 0.900 (Comp. Ex. 3) in composition of barium titanate based semiconductor expressed by Ba_{A}(Ti_{1-α-β}Ga_{α}Nb_{β})_{B}O₃, it was confirmed that particle growth tends to occur and maximum particle diameter tends to be over 1 μm.

Further, as is shown in Table 1, when A/B mole ratio is over 1.060 (Comp. Ex. 4) in composition of barium titanate based semiconductor expressed by Ba_{A}(Ti_{1-α-β}Ga_{α}Nb_{β})_{B}O₃, it was confirmed that different phase of Ba₂TiO₄ tends deposit and a single phase of BaTiO₃ cannot be obtained. Note that different phase of Ba₂TiO₄ combine with CO₂ in air and become BaCO₃, and resolve.

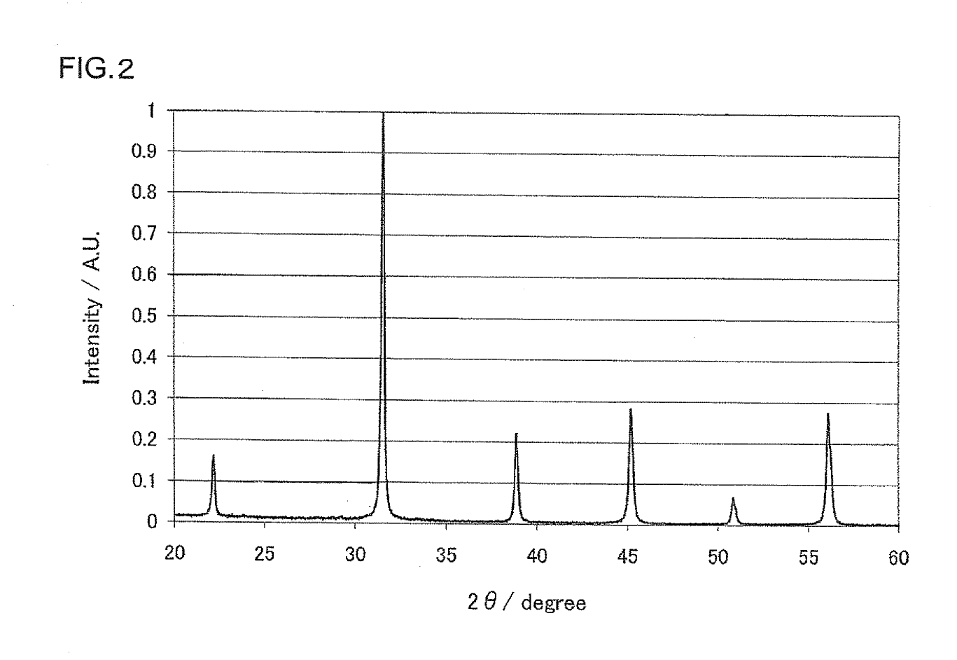

Note that, in the present examples, simultaneous substitution of Ga and Nb to Ti site of BaTiO₃ is obvious from XRD results of synthesized powder of Example 10 shown in FIG. 2. Namely, as is shown in FIG. 2, a peak derived from Ga₂O₃ or Nb₂O₅ cannot be found with the synthesized powder. Further, ionic radiuses of Ga and Nb are 0.620 Angstrom and 0.64 Angstrom, respectively, which is close to 0.605 Angstrom of Ti ionic radius, while distant from 1.61 Angstrom of Ba ionic radius. Thus, Ga and Nb are possible to be preferentially substituted to Ti site and are solid soluted. Further, it was confirmed that Ga and Nb are uniformly solid soluted in BaTiO₃ by taking STEM-EDS analytical photos of synthesized powder of examples 7.

### Example 15

0.5 mole of SiO₂ was added to 100 moles of Ti element in synthesized powder manufactured in example 10, put into a ball mill together with dispersants, evaporative drying was performed after sufficiently wet-mixed in the ball mill, and then heat treated under an air atmosphere at 500° C. for approximately 3 hours to manufacture heat treated powder.

Next, 0.3 mole of Mn was added with respect to 100 moles of Ti element in synthesized powder, and further a suitable amount of organic solvent such as alcohol fuel and plasticizer were added. And then, put into a ball mill together with water, sufficiently wet-mixed in the ball mill, a suitable amount of organic binder and plasticizer were added and sufficiently wet-mixed for a long time and ceramic slurry was obtained.

Next, a forming process was performed to the ceramic slurry by a forming process method such as doctor blade method, and then ceramic green sheet was manufactured so that the thickness become 1 μm after drying.

Next, a screen printing was performed on to the ceramic green sheet by using conductivity paste for internal electrode including Ni, and then conducting film of a predetermined pattern was performed on the ceramic green sheet.

Next, a plural number of ceramic green sheets wherein conducting film is formed were stacked in a predetermined direction, the stacked sheets were sandwiched by ceramic green sheets wherein conducting film is not formed, pressure bonded, cut into a predetermined size and a ceramic stacked body was manufactured.

Next, a removal binder treatment was performed under an air atmosphere at 300 to 500° C., and then, a primary firing was performed under a strongly reducing atmosphere, wherein a predetermined flow ratio of H₂ gas and N₂ gas (e.g. H₂:N₂=1:100) was prepared, at a rising temperature rate of 600° C./hr, holding temperature of 1200° C. for 2 hours, and a sinter a ceramic stacked body was obtained.

Next, a secondary firing was performed under a nitrogen-water vapor atmosphere at a rising temperature rate of 200° C./hour and a holding temperature of 1000° C. for 2 hours, in order not to oxidize internal electrode material of Ni, a grain boundary insulating layer was formed by reoxidation of a semiconductor ceramic, and then component body 1 in which internal electrodes 2 are buried was manufactured.

Next, a conductivity paste including In—Ga eutectic alloy for an external electrode was coated on both sides of component body 1, baking treatment was performed, external electrodes 3a, 3b were formed, and then a multilayer semiconductor ceramic capacitor was manufactured.

Specific permittivity of thus manufactured capacitor was measured with LCR meter (HP4284A by Hewlett Packard). The measurement was performed at a temperature of 20° C., a frequency of 1 kHz, and a measured voltage of 0.5 Vrms. Insulating resistance are the values after direct current of 1V was impressed for 30 seconds at a temperature of 20° C. and are mentioned in a form of resistivity (unit: Ω·μm). Specific permittivity was 35000 and resistivity was 10¹⁰ Ω·μm, which showed good values.

1. A BaTiO₃ based semiconductor ceramic in which Ti site of BaTiO₃ is simultaneously substituted by Ga and Nb.

2. A BaTiO₃ based semiconductor ceramic which is expressed by Ba_{A}(Ti_{1-α-β}Ga_{α}Nb_{β})_{B}O₃, wherein a/8 mole ratio is within a range of 0.92 or more to 100 or less.

3. The BaTiO₃ based semiconductor ceramic as set forth in claim 2, wherein A/B mole ratio is within a range of 0.900 to 1.060.

4. A BaTiO₃ based semiconductor ceramic powder in which Ti site of BaTiO₃ is simultaneously substituted by Ga and Nb, wherein a maximum particle diameter of the BaTiO₃ based semiconductor ceramic powder is 1 μm or less.

5. A BaTiO₃ based semiconductor ceramic powder which is expressed by Ba_{A}(Ti_{1-α-β}Ga_{α}Nb_{β})_{B}O₃, wherein a/6 mole ratio is within a range of 0.92 or more to 100 or less and a maximum particle diameter is 1 μm or less.

6. The BaTiO₃ based semiconductor ceramic powder as set forth in claim 5, wherein A/B mole ratio is within a range of 0.900 or more to 1.060 or less.

7. A multilayer semiconductor ceramic capacitor having a component body in which a semiconductor ceramic layer and an internal electrode are alternately stacked, wherein said semiconductor ceramic layer is constituted from BaTiO₃ based semiconductor ceramic as set forth in claim 1.

8. A multilayer semiconductor ceramic capacitor having a component body in which a semiconductor ceramic layer and an internal electrode are alternately stacked, wherein said semiconductor ceramic layer is constituted from BaTiO₃ based semiconductor ceramic as set forth in claim 2.
